(19) United States
(12) Patent Application Publication
(10) Pub. No.: US 2015/0251112 A1
(43) Pub. Date: Sep. 10, 2015

(54) Splice systems and methods for ropes

(71) Applicant: Daritech, Inc., Lynden, WA (US)

(72) Inventor: David DeWaard, Lynden, WA (US)

(21) Appl. No.: 14/699,608

(22) Filed: Apr. 29, 2015

Related U.S. Application Data
(63) Continuation of application No. 13/797,286, filed on Mar. 12, 2013.
(60) Provisional application No. 61/986,378, filed on Apr. 30, 2014.
(60) Provisional application No. 61/708,028, filed on Sep. 30, 2012.

(51) Int. Cl. B01D 33/073; B01D 33/64; B01D 33/80; B01D 33/044

(52) U.S. Cl. CPC B01D 33/073; B01D 33/044; B01D 33/646; B01D 33/804

(57) ABSTRACT

A dewatering system for removing liquids from feed material comprises a pre-processing stage separator, an output roller press, and a control system. The pre-processing stage separator processes the feed material at a pre-processing rate to obtain a pre-processed mat, where the pre-processed mat contains less liquid than the feed material. The output roller press processes the pre-processed mat at an output rate to obtain an output mat, where the output mat contains less liquid than the pre-processed mat. The control system controls the pre-processing rate based on at least one characteristic of the output mat to maintain the at least one characteristic of the output mat within a predetermined range.

### RELATED APPLICATIONS

This application (Attorney's Ref. No. P218098) claims benefit of U.S. Provisional Application Ser. No. 61/986,378 filed Apr. 30, 2014.

This application (Attorney's Ref. No. P218098) is also a continuation of U.S. patent application Ser. No. 13/797,286 filed Mar. 12, 2013, currently pending.

U.S. patent application Ser. No. 13/797,286 claims benefit of U.S. Provisional Patent Application Ser. No. 61/708,028 filed Sep. 30, 2012, now expired.

The contents of all related applications listed above are incorporated herein by reference.

### TECHNICAL FIELD

The present invention relates to the separation of solid particulates from raw slurry material containing solids and liquids and, in particular, to the separation of solid particulates from raw slurry material comprising at least water and solid particulates.

### BACKGROUND

In many situations, it is desirable to separate a slurry of raw material into constituent solid and liquid components. As one example, while the general composition of municipal waste may be known, any particular gallon of municipal waste may contain a variety of unknown solid or liquid components. Any one of these unknown components may represent an environmental hazard. Accordingly, before municipal waste can be introduced into the environment, it is typically processed to remove any hazardous components. Municipal waste is thus typically processed in a variety of stages designed to remove liquid and solid materials that might be unsuitable for discharge into the environment.

Modern animal husbandry operations such as dairy farms represent another example of a system requiring the processing of a slurry of raw feed material to remove solid particulates. The present invention is of particular significance in the context of processing byproducts from a dairy operation, and that application of the present invention will be described in detail herein. However, the principles of the present invention may be applied to any system in which a slurry of raw material must be processed to remove solid components from the slurry.

In one example, the present invention relates to the removal of liquid material such from raw slurry mixtures generated by a dairy facility so that the liquid and solid materials may be processed separately. More generally, the present invention relates to the removal of liquid material such from any raw slurry mixture so that the liquid and solid materials of the raw slurry mixture may be processed separately.

### SUMMARY

The present invention may be embodied as a dewatering system for removing liquids from feed material comprising a pre-processing stage separator, an output roller press, and a control system. The pre-processing stage separator processes the feed material at a pre-processing rate to obtain a pre-processed mat, where the pre-processed mat contains less liquid than the feed material. The output roller press processes the pre-processed mat at an output rate to obtain an output mat, where the output mat contains less liquid than the pre-processed mat. The control system controls the pre-processing rate based on at least one characteristic of the output mat to maintain the at least one characteristic of the output mat within a predetermined range.

The present invention may be embodied as a dewatering method for removing liquids from feed material comprising the following steps. The feed material is processed at a pre-processing rate to obtain a pre-processed mat, where the pre-processed mat contains less liquid than the feed material. The pre-processed mat is processed at an output rate to obtain an output mat, where the output mat contains less liquid than the pre-processed mat. The pre-processing rate is controlled based on at least one characteristic of the output mat to maintain the at least one characteristic of the output mat within a predetermined range.

### BRIEF DESCRIPTION OF THE DRAWINGS

FIG. 1 is a side elevation view of a first example separator system used in conjunction with a roller press as part of a dewatering system for a dairy facility;

FIG. 2 is a top plan view of the first example separator system and the dewatering system of FIG. 1;

FIG. 3 is rear elevation view of the first example separator system and the dewatering system of FIG. 1;

FIG. 4 is a section, side elevation view of the first example separator system and the dewatering system of FIG. 1;

FIG. 5 is a section, side elevation view of the first example separator system and the dewatering system of FIG. 1 in use;

FIG. 6 is a highly schematic side elevation view of the separator system and first example dewatering system of FIG. 1 in combination with an example control system;

FIG. 7A is a section, side elevation view of a second example separator system for use with a dewatering system in a first configuration;

FIG. 7B is a section, side elevation view of the second example separator system for use with a dewatering system in a second configuration;

FIG. 8 is a highly schematic side elevation view of a second example separator system and dewatering system in combination with an example control system;

FIG. 9 is a highly schematic side elevation view of an example dewatering system of the present invention;

FIG. 10 is a highly schematic side elevation view of an example dewatering system of the present invention;

FIG. 11 is a highly schematic side elevation view of an example dewatering system of the present invention; and

FIG. 12 is a highly schematic side elevation view of an example dewatering system of the present invention.

### DETAILED DESCRIPTION

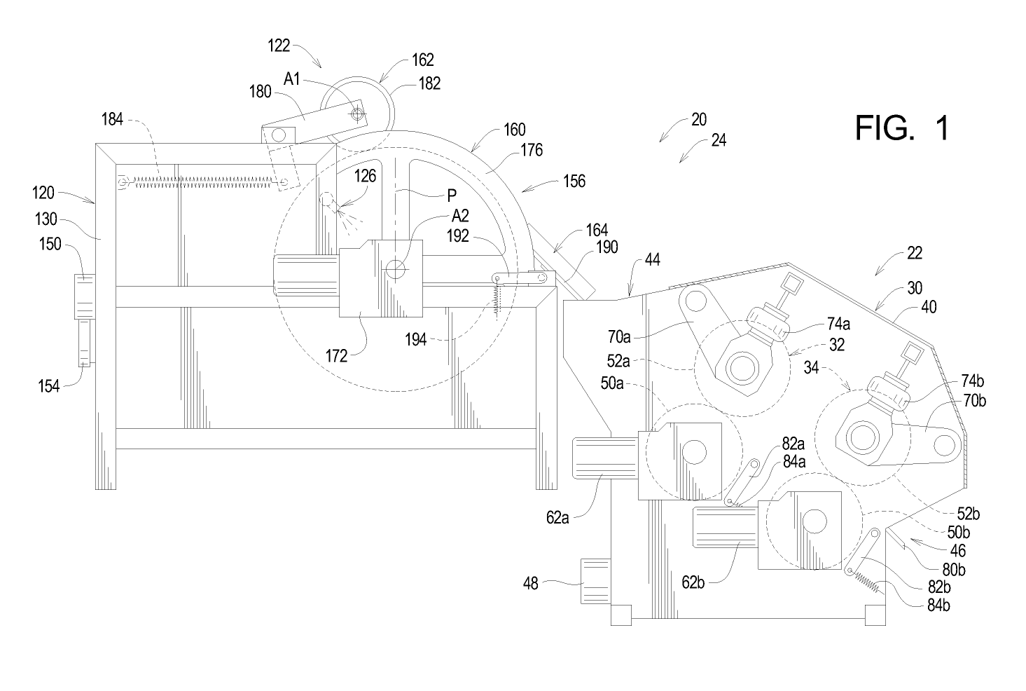

FIGS. 1-5 depict an example separator system 20 constructed in accordance with, and embodying, the principles of the present invention. In FIGS. 1-5, the first example separator system 20 is illustrated in combination with an example roller press system 22 to form a dewatering system 24 adapted for use in a diary facility. The example roller press system 22 is not per se part of the present invention but may be used with the example separator system 20 of the present invention in one common implementation of the principles of the present invention. The example roller press system 22 will thus first be described herein to that extent helpful for a complete understanding of the present invention.

The example roller press system 22 comprises a housing assembly 30, a first roller system 32, a second roller system 34, a feed tray 36, and an inlet tray 38. The example roller press system 22 is thus a dual roller press of a type commonly used in a dairy facility to extract liquids from raw slurry material created when cleaning and maintaining the dairy facility. The present invention may, however, be used with other types of roller presses such as single roller presses.

The housing assembly 30 comprises a housing structure 40 defining a housing chamber 42, a housing inlet 44, a housing solids outlet 46, and a housing liquids outlet 48. The feed tray 36 and the inlet tray 38 are supported by the housing structure 40 below the housing inlet 44.

The example first and second roller systems 32 and 34 are similar and will be described herein together. In addition, similar components of the roller systems 32 and 34 will be assigned the same reference character, with the suffix “a” indicating components of the first roller system 32 and the suffix “b” indicating components of the second roller system 34.

The example roller systems 32 and 34 each comprise a base roller system 50a,b, a press roller system 52a,b, and a scraper system 54a,b. The base roller systems 50a,b each comprise a perforated roller 60a,b and a drive assembly 62a,b. The press roller systems 52a,b each comprise a press arm 70a,b, a press roller 72a,b, and a press member 74a,b. The example press members 74a,b are resilient, inflatable members that can be inflated to a desired pressure, and the magnitude of the desired pressure controls the amount of biasing force applied to the press rollers 72a,b. The example scraper systems 54a,b each comprise a scraper member 80a,b, a scraper arm 82a,b, and a scraper spring 84a,b. The drive assemblies 62a,b drive the perforated rollers 60a,b, respectively.

The press rollers 72a,b need not be driven during normal operation of a roller system such as the roller systems 32 and 34. In the example roller systems 32 and 34, the example first and second press rollers 72a,b are operatively connected to the perforated rollers 60a,b and/or drive assemblies 62a,b by a transmission system (not shown). When an operating anomaly cause the press rollers 72a,b to slip or otherwise stop rotating (e.g., press rollers 72 rotating at significantly more slowly than perforated rollers 70 for a predetermined time period) during operation of the roller systems 32 and 34, the press rollers 72a,b may be driven through the transmission system until the operating anomaly is removed. After the operating anomaly has been removed, the transmission system stops driving the press rollers 72a,b, and these rollers 72a,b return to an idler mode in which they are not driven.

The example roller press system 22 operates generally as follows. Process material to be separated into solids and liquids portions is deposited on the feed tray 36. The process material slides from the feed tray 36 to the inlet tray 38 and against the first base roller system 50a. The process material is carried by the first perforated roller 60a under the first press roller 72a and is then removed by the first scraper member 80a. The process material next slides down the first scraper member 80a and against the second base roller system 50b. The process material is carried by the second perforated roller 60b under the second press roller 72b and is then removed by the second scraper member 80b. The press members 74a,b act on the press arms 70a,b to bias the press rollers 72a,b against the perforated rollers 60a,b to apply an extraction force on the press rollers 72a,b that squeezes or presses liquids out of the process material but allows slight movement of the press rollers 72a,b relative to the perforated rollers 60a,b. The scraper springs 84a,b act on the scraper members 80a,b through the scraper arms 82a,b to hold the scraper members 80a,b against the perforated rollers 60a,b.

The Applicants have recognized that the effectiveness of a roller press varies based on factors such as the characteristics of the process material, the flow rate of the process material onto the feed tray, and localized variations in the composition and thickness of the process material on the feed tray. The example separator system 20 is in one example form used in conjunction with the example roller press system 22 in the context of the dewatering system 24, and the example separator system 20 increases the effectiveness of the roller press system 22 in that context as will now be described in detail below. The example separator system 20 may, however, be used by itself or as part of a larger system other than a dewatering system such as the example dewatering system 24.

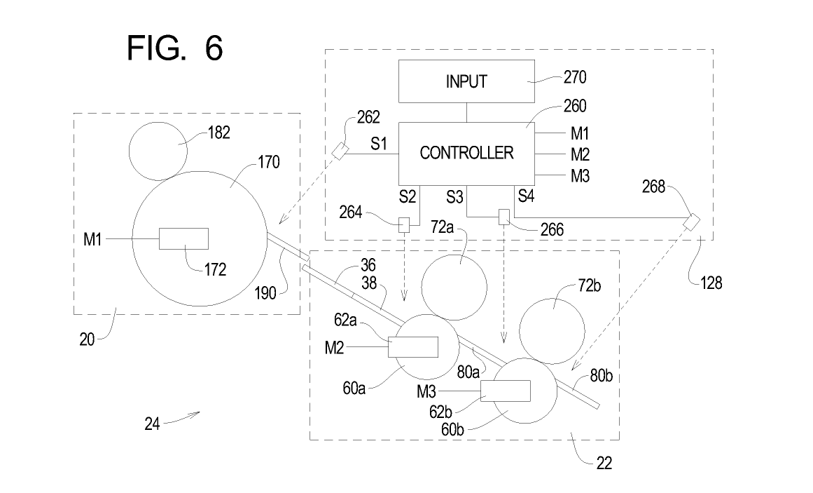

Referring now to the details of the example separator system 20, the example separator system 20 comprises a housing assembly 120 and a roller system 122. The example separator system 20 further comprises a level control system 124 and/or a spray system 126. In the context of the example dewatering system 24, the separator system 20 and roller press system 22 may further be used with a control system 128 as depicted in FIG. 6. And, as will be explained in further detail below, the control system 128 may further be adapted to improve the performance of the separator system 20 outside the context of the example roller press system 22 and/or dewatering system 24.

Referring initially to the housing assembly 120, the example housing assembly 120 comprises a housing structure 130, a feed trough 132, a collection trough 134, a first side seal member 136, a second side seal member 138, and a bottom seal member 140. The housing structure 130 supports the feed trough 132, the first and second side seal members 136 and 138, and the bottom seal member 140 relative to the roller system 122 such that the housing assembly 120 and roller system 122 define a feed chamber 142. The housing structure 130 supports the collection trough 134 such that the housing assembly 120 defines a collection chamber 144. The feed chamber 142 defines a trap portion 146.

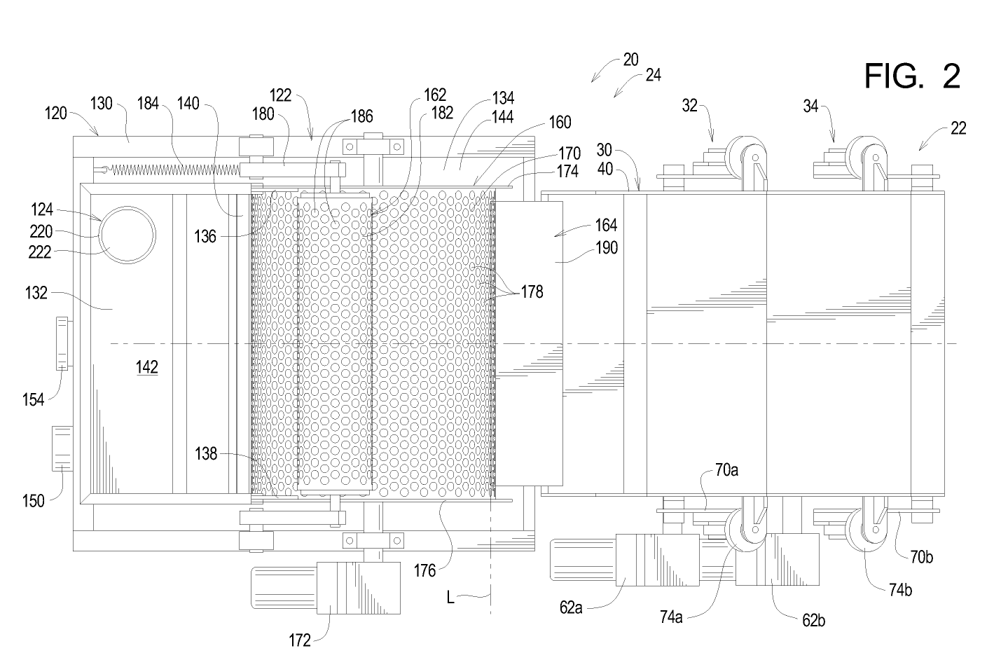

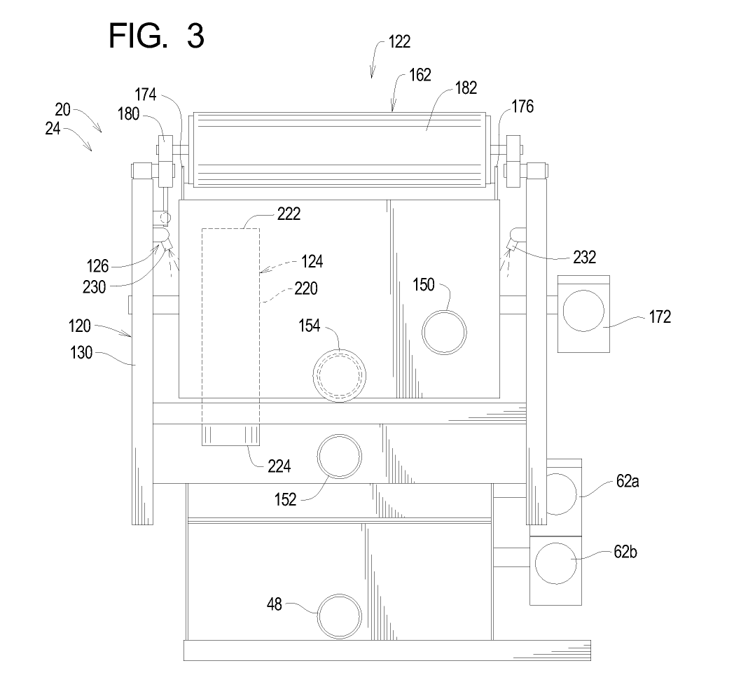

The housing assembly 120 further defines an inlet 150, a main outlet 152, a drain outlet 154, and a solids opening 156. The inlet 150 and drain outlet 154 are in fluid communication with the first housing or feed chamber 142. The main outlet 152 is in fluid communication with the second housing or collection chamber 144. As perhaps best shown in FIGS. 1, 3, 4, and 5, the example inlet 150 is located at least partly above the drain outlet 154. Further, for reasons that will become apparent from the following discussion, the example inlet opening 150 is spaced on an opposite side of the feed chamber 142 from the level control system 124 as perhaps best shown in FIGS. 2 and 3.

The example roller system 122 comprises a base roller system 160, a press roller system 162, and a scraper system 164. The example base roller system 160 comprises a base roller 170 and a drive system 172. First and second roller flanges 174 and 176 extend from the base roller 170. A matrix of base perforations 178 are formed in the cylindrical surface defined by the base roller 170. The example drive system 172 comprises a motor directly connected to an axle of the base roller 170, but other drive systems may be used to rotate the base roller 170.

The example press roller system 162 comprises a press arm 180, a press roller 182, and a press spring 184. The cylindrical surface of the example press roller 182 is also perforated and defines a matrix of press perforations 186. The example scraper system 164 comprises a scraper member 190, a scraper arm 192, and a scraper spring 194.

The example perforations 178 and 186 are circular and have a diameter of ⅛″, and approximately 30% of the cylindrical surfaces of the base roller 170 and press roller 182 are open. However, perforations of different shapes, cross-sectional areas, and densities may be used. For example circular perforations having a diameter of 3/16″ (approximately 50% open) or 1/16″ (approximately 30% open) may also be used. The exact opening cross-sectional area and percent per unit area open are not critical so long as the structural integrity of the rollers 170 and 182 is maintained, the liquids are capable of flowing through the base perforations 178, and the press perforations 186 prevent the material being pressed from adhering to the roller 182. In addition, the base perforations 178 need not be the same size and/or shape as the press perforations 186, and it may be desirable to make the base perforations 178 larger or smaller than the press perforations 186.

The example base roller 170 is supported for axial rotation by the housing assembly 120 such that the first and second side seal members 136 and 138 engage the first and second base roller flanges 174 and 176, respectively, and such that the bottom seal member 140 engages the base roller 170. The example bottom seal member 140 is rotatably attached to the collection trough 134 such that gravity and the weight of any material within the feed chamber holds the bottom seal member 140 against the base roller 170 as the bottom seal member 140 wears. With the base roller 170 so supported by the housing assembly 120, the feed chamber 142 formed thereby is not fluid tight but will contain liquid and solid material as will be described in further detail below.

The example press arm 180 supports the press roller 182 against the base roller 170, and the example press spring 184 is configured to bias the press arm 180 such that the press roller 182 is forced or held against the base roller 170. In the example roller system 122, the example press arm 180 supports the press roller 182 such that an axis of rotation A1 of the press roller 182 is offset by an angle of approximately 10 degrees and or within a first range of 0-20 degrees towards the feed chamber 142 relative to a vertical plane P extending through an axis of rotation A2 of the base roller 170 (on the incline of the base roller 170). However, it is possible to arrange the axis of rotation A1 of the press roller 182 at other angular locations around the base roller 170 such as on the decline side of the base roller 170.

The example scraper arm 192 supports the scraper member 190 such that the scraper member 190 contacts the base roller 170 at a scrape line L. The scrape line L is substantially parallel to the axes A1 and A2, is arranged on an opposite side of the vertical plane P from the press roller 182 (on the decline of the base roller 170), and lies within a reference plane extending through the axis A2 of the base roller 170. The reference plane extends at an angle of approximately 60-90 degrees relative to the vertical plane P but the scrape line L may be arranged at other locations in other embodiments of the invention. In addition, the example scraper member 190 extends at an angle of approximately 5-30 degrees relative to a direction tangential to the surface of the base roller 170 at the scrape line L, but other angles may be used so long as the scraper member 190 is capable of removing material from the base roller 170. The example scraper spring 194 biases the scraper arm 192 such that the scraper member 190 is held in contact with the base roller 170 as the scraper member 190 wears.

The example level control system 124 comprises a level control tube 220 and defines a level control inlet 222 and a level control outlet 224. The example level control tube 220 is supported relative to the housing assembly 120 such that the level control inlet 222 is within the feed chamber 142 and the level control outlet 224 is outside of the feed chamber 142. Further, the example level control system 124 is configured such that a vertical location of the level control inlet 222 relative to the feed chamber 142 may be adjusted. In the example level control system 124, the level control tube 220 may be reconfigured (e.g., telescoping structure, folding structure, accordion structure) to adjust the relative vertical location of the level control inlet 222 or, alternatively, the entire level control tube 220 may be moved up and down to adjust the relative vertical location of the level control inlet 222.

The example spray system 126 comprises first and second spray heads 230 and 232 configured to spray cleaning fluid such as water onto one or more surfaces of the base roller 170.

In use, feed material 240 is introduced or forced under pressure into the feed chamber 142 through the inlet 150 until the level of the feed material 240 reaches a desired level. In the example separator system 20, the desired level is determined by the relative vertical location of the level control inlet 222. Further, as discussed above, the inlet 150 is spaced below the surface of the feed material 240 within the feed chamber 142 and on the opposite side of the feed chamber 142 from the level control inlet 222 defined by the level control tube 220.

The volume of feed material 240 forced into the feed chamber 142 will typically be more than can be taken up by the base roller 170 as will be described in further detail below, so excess feed material 240 circulates through the feed chamber 142 and out of the level control inlet 222 during normal operation of the separator system 20.

Because the feed material 240 entering feed chamber 142 circulates under pressure within the feed chamber 142, the feed material 240 is agitated to ensure that a solids portion of the feed material 240 is mixed within the feed chamber 142 before being picked up by the base roller 170. This circulation encourages even coating of the base roller 170 with the solids portion of the feed material 240. In some situations, a separate agitation system may be provided within the feed chamber 142 if the circulation of the feed material 240 is insufficient to mix the solids evenly throughout the surface of the feed material adjacent to the base roller 170.

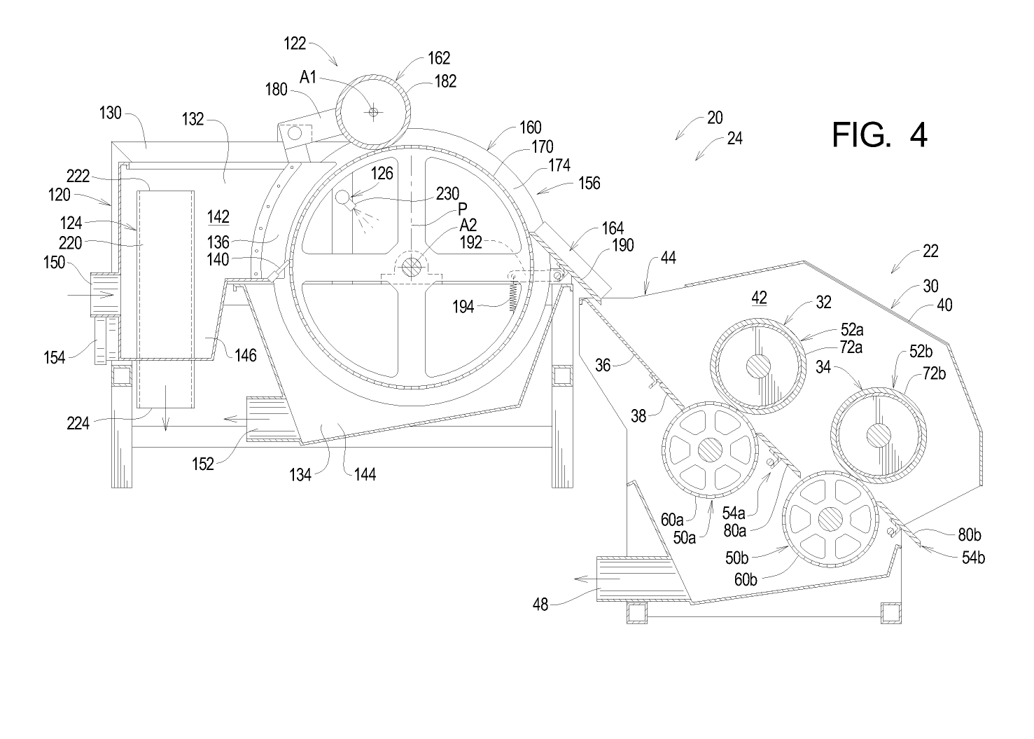

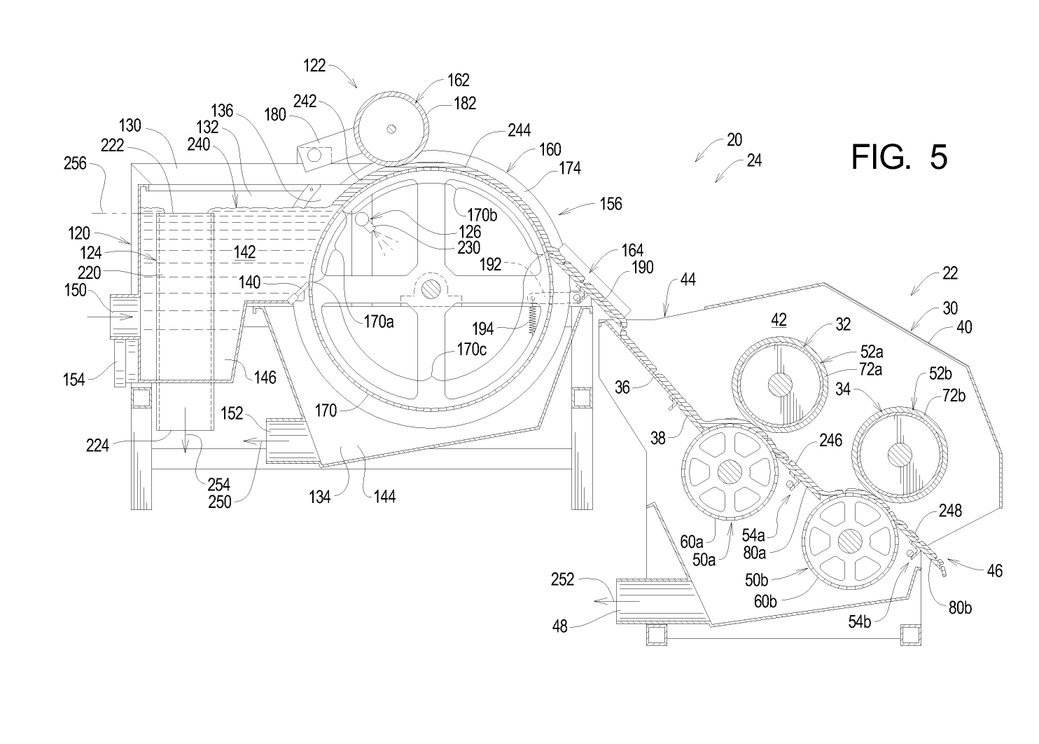

As discussed above, the feed chamber 142 is not fluid tight and in fact need not be fluid tight. Initially, the base perforations 178 in the base roller 170 will allow some portion of the liquids within the feed chamber 142 to exit the feed chamber 142. Another portion of the liquids within the feed chamber 142 will leak between the side seal members 136 and 138 and the bottom seal member 140. However, as shown in FIGS. 4 and 5, the collection chamber 144 is arranged below the locations where the liquids will leak or exit from the feed chamber 142. The imperfect seal formed by the seal members 136, 138, and 140 and the base perforations 178 in the base roller 170 thus function to remove or separate at least a portion of the liquids in the feed material 240. However, the imperfect seals and base perforations 178 should not be so large as to allow an appreciable amount of the type of solids within the feed material 240 that are to be collected by the separator system 20, or the dewatering system 24, to leak out of the feed chamber 142 with the liquids.

When the feed material 240 reaches the desired level, the drive system 172 is operated to rotate the base roller 170 at a desired speed such that the cylindrical surface defined by the roller 170 rotates out of the feed chamber 142 (clockwise in FIGS. 1, 4, and 5). The desired level and the desired speed will be determined by such factors as the composition of the feed material 240 and the operating characteristics of the example roller system 122.

As the base roller 170 rotates, a portion of the feed material 240 in contact with the perforated, cylindrical surface of the base roller 170 is carried in a feed solids mat 242 up by the base roller 170 as shown in FIG. 5. The feed solids mat 242 carried up by the base roller 170 is a loose mat comprised primarily, but not exclusively, of the solids within the feed material 240. In particular, the feed solids mat 242 comprises solids that are, at this point, still relatively soaked with a liquid portion of the feed material 240.

The feed solids mat 242 is carried between the base roller 170 and the press roller 182. As generally described above, the press roller 182 is biased towards the base roller 170 such that the feed solids mat 242 is pressed between the press roller 182 and the base roller 170 to form a separated solids mat 244. A substantial portion of the liquid material carried by the feed solids mat 242 is thus squeezed out of the feed solids mat 242 and drains through the base perforations 178 substantially along a line at which the base roller 170 and the press roller 182 are closest together. The liquid material squeezed out of the feed solids mat 242 continues to fall through an interior of the base roller 170 and drain through the perforations at the bottom of the base roller 170. The liquid material that drains through the perforations at the bottom of the base roller 170 is collected in the collection chamber 144 formed by the collection trough 134. Accordingly, the separated solids mat 244 that has passed between the base roller 170 and the press roller 182 has a lower liquid or moisture content than that of the feed solids mat 242.

The Applicants have found that providing the press perforations 186 in the press roller 182 reduces the tendency of at least a portion of the solids mat 242 to be picked up by the press roller 182. Accordingly, substantially the entire feed solids mat 242 on the base roller 170 passes between the base roller 170 and the press roller 182 to form the separated solids mat 244.

Further, because the feed solids mat 242 is developed by the interaction of the rotating base roller 170 with the feed material 240 in the feed chamber 142, and because the feed material 240 within the feed chamber 142 is agitated by the circulation of the feed material 240 through the feed chamber 142, the feed solids mat 242 and the separated solids mat 244 obtained therefrom are of relatively even and consistent thickness and composition along a lateral dimension of the base roller 170 transverse to the direction of rotation of the base roller 170.

In addition, the feed material 240 may contain floating solid detritus material not suitable for further processing and which should not be picked up by the base roller 170 to form the feed solids mat 242. For example, in the context of a dairy operation, the feed material 240 may comprise hoof blocks that should not be processed with the material forming the feed solids mat 242. Such hoof blocks will float on top of the feed material 240 within the feed chamber 142 but will not be picked up by the base roller 170 to form a part of the feed solids mat 242. With sufficient agitation and circulation of the feed material 240 within the feed chamber 142, such floating solid detritus will eventually exit the feed chamber 142 through the level control inlet 222 defined by the level control system 124. A filter may be used outside of the separator system 20 to remove such floating solid detritus during circulation of the feed material 240.

The separated solids mat 244 is removed from the perforated cylinder 170 by the scraper member 190. The separated solids mat 244 is displaced along the scraper member 190 by gravity and/or is crowded by subsequent portions of the separated solids mat 244 such that separated solids mat 244 is eventually transferred to or falls onto the feed tray 36 of the roller press system 22. Gravity and/or crowding by subsequent portions of the separated solids mat 244 causes the separated solids mat 244 to be further displaced along the feed tray 36 and onto the inlet tray 38. During this process, the thickness and consistency of the separated solids mat 244 along a lateral dimension of the feed tray 36 and/or inlet tray 38 is substantially maintained.

The separated solids mat 244 is eventually passed to the first roller system 32. Because the separated solids mat 244 has maintained its substantially uniform thickness and consistency along the lateral dimension of the inlet tray 38, an even pool or batch of the separated solids mat 244 collects at the juncture of the rollers 60a and 72a of the first roller system 32, allowing the first roller system 32 efficiently to press or squeeze the separated solids mat 244 to obtain a first pressed mat 246. The first pressed mat 246 has a lower liquid or moisture content than the separated solids mat 244. The first pressed mat 246 is subsequently removed from the first perforated roller 60a by the first scraper member 80a. Again, the thickness and consistency of the first pressed mat 246 along a lateral dimension of the first scraper member 80a is substantially maintained.

The first pressed mat 246 is then passed to the second roller system 34. Again, the first pressed mat 246 maintains a substantially uniform thickness and consistency along a lateral dimension of the scraper member 80a, so an even pool or batch of the first pressed mat 246 collects at the juncture of the rollers 60b and 72b of the second roller system 34, allowing the second roller system 34 efficiently to press or squeeze the first pressed mat 246 to obtain a second pressed mat 248. The second pressed mat 248 has a lower liquid or moisture content than the first pressed mat 246. Typically, a rotation speed of the perforated roller 60a of the first roller system 32 will be slightly greater than a rotational speed of the perforated roller 60b of the second roller system 34. The second pressed mat 248 is removed from the second perforated roller 60b by the second scraper member 80b. Again, the thickness and consistency of the second pressed mat 248 along a lateral dimension of the second scraper member 80b is substantially maintained.

In the example dewatering system 24, the second pressed mat 248 is collected from the second scraper member 80b for further processing and/or disposal.

FIG. 5 further shows that a first extracted material 250 collects in the collection trough 134 and is removed from the collection trough 134 through the main outlet 152. The first extracted material 250 comprises the liquids squeezed out of the feed solids mat 242 and possibly some smaller solids that have flowed through the perforations 172 and/or leaked from the feed chamber 142 as generally described above.

As described above, the trap portion 146 of the feed chamber 142 is located below the inlet 150, so heavier debris such as rocks entrained within the feed material 240 entering the feed chamber 142 will sink within the feed chamber 142 and be collected in the trap portion 146. The drain outlet 154 allows such debris that has collected in the trap portion 146 to be removed from the feed chamber 142.

Similarly, a second extracted material 252 removed by the first and second roller systems 32 and 34 is collected by the housing structure 40 of the roller press system 22 and flows out of the housing liquid outlet 48 defined by the housing structure 40.

In addition, an over flow feed material 254 flows through the level control inlet 222 to maintain the top of the feed material 240 within the feed chamber 142 at a desired level 256. The desired level 256 will be determined by factors such as the composition and volume of the feed material 240, the rotational speed of the base roller 170, and the desired thickness of the feed solids mat 242. Typically, the desired level 256 will be set for a particular operating environment and adjusted only when the conditions of that operating environment change.

After flowing into the level control inlet 222, the overflow feed material 254 flows out of the separator system 20 through the level control outlet 224. Typically, the overflow feed material 254 is returned to the source of the feed material and recirculated or forced back into the feed chamber 142. Again, the desired level 256 may be altered by altering a relative vertical location of the level control inlet 222.

The solids content of the feed material 240 tends to fluctuate over time depending upon what is happening in the facility upstream of the separator system 20. However, the separating function performed by the interaction of the feed material 240 within the feed chamber 142 with the base roller 170 is effectively self-regulating, and changes in the solids content of the feed material 240 entering the example separator system 20 do not adversely affect the operation thereof. In particular, during normal operation of a facility that generates waste forming the feed material 240, the level of solids in the feed material 240 may be below a first value most of the time but may periodically spike or increase for short periods of time to significantly greater than the first value. During such increases, the base roller 170 continues to pick up the solids portion at a consistent rate, and any excess solids in the feed material 240 is simply returned to its source (e.g., a collection pit not shown in the drawings) through the level control inlet 222. From the source, the feed material 240 is eventually returned to the feed chamber 142, but, in the meantime, the condition causing the short-term spike or increase in solids level may have passed. The example separator system 20 simply continues to operate until the “slug” of solids created by the short term increase in the solids level is eventually processed. However, such “slugs” of solids typically will not cause the example separator system 20 to cease operating, operate inefficiently, or otherwise malfunction.

FIG. 5 further shows that the example separator system 20 is configured such that a substantial portion of the perforated base roller 170 is below the level of the feed material 240 within the feed chamber 142. In particular, the base roller 170 defines a first, submerged region 170a and a second, working region 170b. The submerged portion 170a of the base roller 170 is in contact with the feed material 240 below the desired level 256 of the feed material 240. The working region 170b extends from the desired level 256 to the scrape line L at which the scraper member 190 comes in contact with the base roller 170. A return region 170c of the base roller 170 is defined at the bottom of the base roller 170 between the working portion 170b and the submerged portion 170a.

The portion of the base roller 170 in the return region 170c is cleaned by the scraper system 164 on the outside and rinsed by the spray system 126 on the inside so that the base perforations 178 are clean by the time these perforations rotate back into the submerged region 170a. Accordingly, at the time the base perforations 178 rotate back into the submerged region 170a, fluid is able to flow relatively freely through these perforations 178.

Further, the feed material 240 above the submerged region 170a of the base roller 170 creates head pressure that dynamically forces liquids through the base perforations 178 in the submerged region 170a of the base roller 170. This head pressure thus actively forces the feed material 240 towards the base roller 170 and through the base perforations 178. Any solids entrained in the liquid portion of the feed material 240 are thus actively carried against the base roller 170 within the submerged region 170a and are carried up and out of the feed material 240 in the feed solids mat 242 as described above.

Accordingly, as determined by such factors as the volume and characteristics of the feed material 240, capacity of the base roller 170, and characteristics of the roller press system 22, the axis of rotation of the base roller 170, the inlet 150, and the desired level 256 of the feed material 240 should be determined to maintain sufficient head pressure on the feed material 240 within the feed chamber 142 to force a liquids portion of the feed material 240 through the base perforations 178 in the base roller 170.

In addition, the separator system 20 is designed to operate such that the desired level 256 of the feed material 240 is always at or slightly above the height of the level control inlet 222. With the feed material 240 at the desired level 256, the feed material 240 thus constantly recirculates into the inlet 150, through the feed chamber 142, and out of the feed chamber through the level control inlet 222 or the perforations 178, and dynamic head pressure on the feed material 240 is kept above a level sufficient to actively force the liquids portion of the feed material 240 to flow through the base perforations 178 as described above. This active forcing of liquids through the perforations 178 causes the solids portion of the feed material to be drawn towards the base roller 170.

The spray system 126 is configured such that pressurized cleaning liquid is sprayed on one or more surfaces of the base roller 170 to prevent build-up of debris on the surfaces of the roller 170 and in particular the spokes thereof.

As generally described above, the drive system 172 can rotate the base roller 170 at a variable rate to control the parameters of the separated solids mat 244 that is fed into the first roller system 32. For example, rotating the base roller 170 at a different rate can pick up more solids and thus develop a thicker separated solids mat 244. The revolution speed of the base roller 170 thus can be adjusted as necessary for a particular feed material and the characteristics of the roller system 122.

Referring now to FIG. 6 of the drawing, the example control system 128 will now be described in further detail. The example control system 128 comprises a controller 260 and first, second, third, and fourth sensors 262, 264, 266, and 268. The sensors 262, 264, 266, and 268 are laser based devices capable of measuring the distance and can be configured to generate a signal that corresponds to a thickness of the mats 244, 246, and/or 248.

If used, the example first sensor 262 is configured to generate a thickness signal S1 indicative of a thickness of the separated solids mat 244 as the separated solids mat 244 collects on the scraper member 190. If used, the example second sensor 264 is configured to generate a thickness signal S2 indicative of a thickness of the separated solids mat 244 as the separated solids mat 244 collects or pools up at the juncture of the rollers 60a and 72a of the first roller system 32. If used, the example third sensor 266 is configured to generate a thickness signal S3 indicative of a thickness of the first pressed mat 246 as the first pressed mat 246 collects or pools up at the juncture of the rollers 60b and 72b of the second roller system 34. The example fourth sensor 268 also may be used and, if so, is configured to generate a thickness signal S4 indicative of a thickness of the second pressed mat 248 as the second pressed mat 248 is collected on the second scraper member 80b of the second roller system 34.

The relative moisture content of the solids material forming the mats 244, 246, and 248 is difficult to measure directly, but the thickness of the mats 244, 246, and 248 generally correlates to the absolute moisture content of the solids material forming these mats 244, 246, and 248. Accordingly, the absolute moisture content of the various mats 244, 246, and 248 can be estimated and/or calculated based on one or more of the thickness signals S1, S2, S3, and S4.

Based on one or more of the thickness signals S1, S2, S3, and S4, the controller 260 generates motor control signals M1, M2, and/or M3 for controlling one or more of the drive system 172 of the separator system 20, the drive system 62a of the first roller system 32, and the drive system 62b of the second roller system 34, respectively. In general, the first and second thickness signals S1 and S2 will be used to control the drive system 172 to control a rotational speed of the base roller 170. The third thickness signal S3 will be used to control the drive system 62a to control a rotational speed of the first perforated roller 60a. The fourth thickness signal S4 will be used to control the drive system 62b to control a rotational speed of the second perforated roller 60b.

The example controller 260 is thus programmed for a particular environment to optimize throughput while maintaining a moisture content of the second pressed mat 248 at a desired level or within a desired range of levels. For example, if the fourth thickness signal S4 indicates that the second pressed mat 248 exceeds a predetermined range, it can be inferred that a moisture content of the second pressed mat 248 is too high. The rotational speed of the second perforated roller 60b will thus be reduced until the thickness of the second pressed mat 248 falls within the predetermined range. And if the thickness signal S4 indicates that the second pressed mat 248 is below the predetermined range, it can be inferred that the dewatering system 24 is not operating at optimized throughput, and the rotational speed of the second perforated roller 60b will be increased until the thickness of the second pressed mat 248 falls within the predetermined range.

The thickness of the first pressed mat 246 indicated by the third thickness signal S3 can indicate excessive build-up of the first pressed mat 246 behind the second roller system 34. In this case, the rotational speed of the first perforated roller 60a may be reduced to eliminate the excessive build-up of the first pressed mat 246. And if the thickness of the first pressed mat 246 indicated by the third thickness signal S3 indicates insufficient pooling or supply of the first pressed mat 246 behind the second roller system 34, the rotational speed of the first perforated roller 60a may be increased to ensure adequate supply of the first pressed mat 246 to the second roller system 34.

Similarly, a thickness of the separated solids mat 244 indicated by the second thickness signal S2 can indicate excessive build-up of the separated solids mat 244 behind the first roller system 32. In this case, the rotational speed of the base roller 170 may be reduced to eliminate the excessive build-up of the separated solids mat 244. And if a thickness of the separated solids mat 244 indicated by the second thickness signal S2 indicates insufficient pooling or supply of the separated solids mat 244 behind the first roller system 32, the rotational speed of the base roller 170 may be increased to ensure adequate supply of the separated solids mat 244 to the first roller system 32.

In addition to or instead of using the second thickness signal S2, a thickness of the separated solids mat 244 indicated by the first thickness signal S1 can be used to indicate an excessive quantity, amount, or volume of material in the separated solids mat 244. In this case, the rotational speed of the base roller 170 may be reduced to eliminate the excessive thickness of the separated solids mat 244. And if a thickness of the separated solids mat 244 indicated by the second thickness signal S2 indicates that the separated solids mat 244 is too thin, the rotational speed of the base roller 170 may be increased to increase a thickness of the separated solids mat 244.

When the example separator system 20 is used in conjunction with the roller press system 22 to form the dewatering system 24, the use of the second sensor 264 to generate the second thickness signal S2 is preferred to the use of the first sensor 262 to generate the first thickness signal S1, and the second sensor 264 and not the first sensor 262 will be provided. However, if the example separator system 20 is used in a stand-alone mode or as part of another larger system, the first sensor 262 may be used to control the rotation speed of the base roller 170.

The controller 260 may further be provided with an input system 270 that allows parameters of the control system 128 to be changed. Typically, each system in which the separator system 20 and/or dewatering system 24 may be used will have different operating conditions requiring different system parameters. The operating conditions may vary from facility to facility and, for a given facility, from day to day. The operator may change the system parameters for a given operating set of operating conditions to optimize the operation of the separator system 20 and/or the dewatering system 24.

As discussed above, the separator system 20 may be used in a stand-alone mode. In this case, the control system 128 may be provided only with the first sensor 262 and/or the second sensor 264, and the controller 260 will control operation of the drive system 172 using only the first and second thickness signals S1 and S2.

The use of the example separator system 20 in combination with the example roller press system 22 as part of a larger dewatering system 24 allows parameters of the dewatering system 24 to be controlled to at least partly accommodate variations in the characteristics of the process material, to adjust the flow rate of the process material onto the feed tray 36, and to minimize localized variations in the composition and thickness of the process material on the feed tray 36. The use of the separator system 20 to supply process material to the roller press system 22 optimizes the operation of the roller press system 22 and in terms of both the amount of material processed during a given time period and the dryness of the material processed by the roller press system 22.

However, the example separator system 20 may have use outside the context of the dewatering system 24. For example, the example separator system 20 may be used as a standalone dewatering system if the moisture content of the material processed by the separator system 20 is sufficient for a particular purpose. As another example, the example separator system 20 may be used as part of any larger processing system other than a dewatering system like the example dewatering system 24 in which solids are to be removed from slurry containing solids and liquids, especially when the solids are desirably arranged in a mat having relatively consistent thickness and composition.

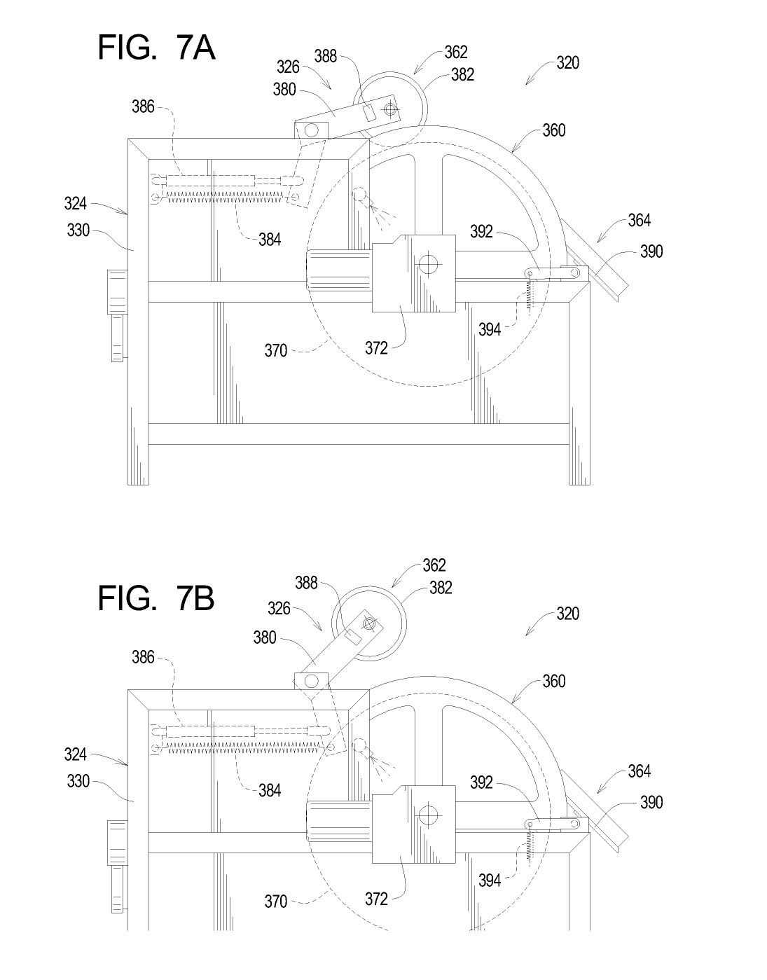

Referring now to FIGS. 7A and 7B of the drawing, depicted therein is a second example separator system 320 constructed in accordance with, and embodying, the principles of the present invention. The second example separator system 320 is similar to the first example separator system 20 described above and will be described below only to the extent necessary for a complete understanding of the present invention. In that context, the second example separator system 320 may be operated in conjunction with a roller press system such as the example roller press system 22 described above as part of a dewatering system 322. Accordingly, the second example separator system 320 will be discussed herein in conjunction with the example roller press system 22 as described above.

Referring now to the details of the example separator system 320, the example separator system 320 comprises a housing assembly 324 and a roller system 326. In the context of the example dewatering system 322, the second example separator system 320 and roller press system 22 may further be used with a control system 328 as depicted in FIG. 8. And as will be explained in further detail below, the control system 328 may further be adapted to improve the performance of the separator system 320 outside the context of the example roller press system 22 and/or dewatering system 24.

Referring initially to the housing assembly 324, the example housing assembly 324 comprises a housing structure 330. The housing structure 330 of the housing assembly 324 and the roller system 326 define a feed chamber.

The example roller system 326 comprises a base roller system 360, a press roller system 362, and a scraper system 364. The example base roller system 360 comprises a base roller 370 and a drive system 372. As with the example base roller 170 described above, a matrix of perforations is formed in a cylindrical surface defined by the base roller 370.

The example press roller system 362 comprises a press arm 380, a press roller 382, a press spring 384, a press actuator 386, and a rotation sensor 388. The cylindrical surface of the example press roller 382 is also perforated and, like the example press roller 182 described above, defines a matrix of perforations. The example scraper system 364 comprises a scraper member 390, a scraper arm 392, and a scraper spring 394.

The example base roller 370 is supported for axial rotation by the housing assembly 324. With the base roller 370 supported by the housing assembly 324, the feed chamber formed thereby is not fluid tight but will contain liquid and solid material as described above with reference the example feed chamber 142.

The example press arm 380 supports the press roller 382 against the base roller 370, and the example press spring 384 is configured to bias the press roller 382 through the press arm 380 against the base roller 370.

The press actuator 386 is configured to operate in a first configuration as shown in FIG. 7A and a second configuration as shown in FIG. 7B. With the press actuator 386 in the first configuration, the press roller 382 is biased by the press spring 384 against the base roller 370 in a first position as shown in FIG. 7A. With the press actuator 386 in the second configuration, the press actuator 386 acts on the press arm 380 against the force of the press spring 384 such that the press roller 382 is rotated from the first position shown in FIG. 7A into a second position as shown in FIG. 7B. In the second position, the press roller 382 is spaced a predetermined distance away from the base roller 370.

Referring now to FIG. 8 of the drawing, it can be seen that the second example control system 328 is or may be similar to the first control system 128 described above. The second example control system 328 will be described herein only to the extent that it differs from the example control system 128.

In particular, the example control system 328 comprises a controller 420, and a first sensor 422, a second sensor 424, a third sensor 426, and a fourth sensor 428. An input device 430 is configured to allow a user to interface with the controller 420.

Like the example sensors 262, 264, 266, and 268 described above, the sensors 422, 424, 426, and 428, are arranged to generate signals S1, S2, S3, and S4, respectively. Again, at least some of these signals S1, S2, S3, and S4 are optional, and the present invention may be embodied with control systems other than the specific control systems 128 and 328 described herein.

The signals S1, S2, S3, and S4 are transmitted to the controller 420. In the example dewatering system 322, the controller 420 generates signals M1, M2, and M3 for controlling the drive system 372 of the second example separator system 320 and the drive assemblies 60a and 60b of the example roller press system 22, respectively, in response to the signals S1, S2, S3, and S4.

In addition, the example controller 420 is configured to generate an actuator control signal A1 in response to a fifth sensor signal S5 generated by the rotation sensor 388. In particular, the rotation sensor 388 is configured to determine whether the press roller 382 is rotating. For example the rotation sensor 388 may be configured to detect rotation of a hub of the press roller 382.

If the sensor signal S5 generated by the rotation sensor 388 indicates that the press roller 382 is rotating, the controller 420 generates the actuator signal A1 to place the press actuator 386 in its first configuration, and the press spring 384 holds the press roller 382 in the first position against the base roller 370 as shown in FIG. 7A. If, however, the sensor signal S5 generated by the rotation sensor 388 indicates that the press roller 382 is not rotating, the controller 420 generates the actuator signal A1 to place the press actuator 386 in its second configuration, and the press actuator 386 rotates the press roller 382 from the first position into the second position as shown in FIG. 7B. Again, the press roller 382 is spaced from the base roller 370 in the second position.

During operation of the second example separator system 320, the feed material 240 may contain or develop a “clump” of solids that is carried up the base roller 370 but cannot pass beneath the press roller 382. In this case, the press roller 382 stops rotating, and the separator system 320 operates in a press roller fault mode. When the press roller fault is detected, the rotation sensor 388 generates the sensor signal S5 to indicate that the press roller 382 has stopped rotating. In response, the controller 420 generates the actuator control signal A1 to actuate the press actuator 386 such that the press roller 382 is raised. After the press roller 382 raises into the second position, the base roller 370 carries the “clump” of solids past the press roller 382 and eventually to the scraper member 390. The scraper member 390 removes the “clump” of solids.

The controller 420 is programmed to generate the actuator signal A1 such that the press roller 382 is held in the second position for a predetermined period of time. After the predetermined period of time lapses, the controller 420 generates the actuator signal A1 such that the press roller 382 is returned to the first position from the second position. In this first position, the sensor 388 verifies that the press roller 382 is rotating normally. If the press roller 382 is rotating normally, the second example separator system 320 returns to its normal operating mode from the press roller fault mode. If the press roller 382 is not rotating normally, the fault roller lifting process may be performed again to clear the press roller fault mode. If the press roller fault mode persists, the operator may be notified, and additional steps may be taken to clear the press roller fault.

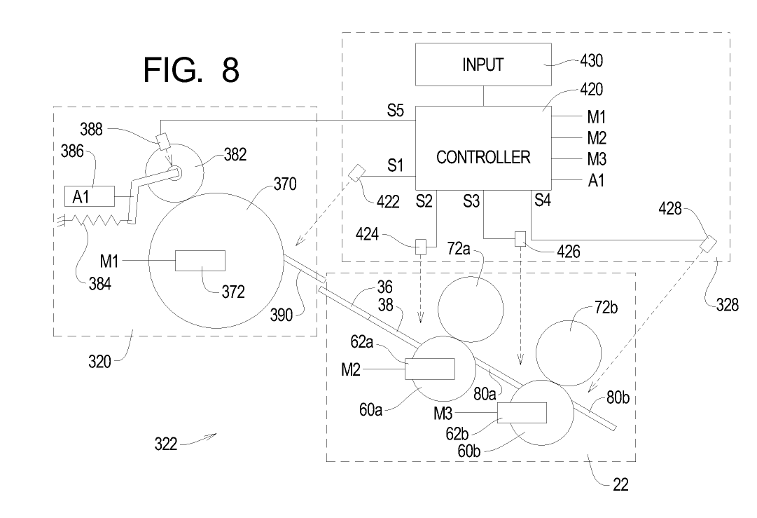

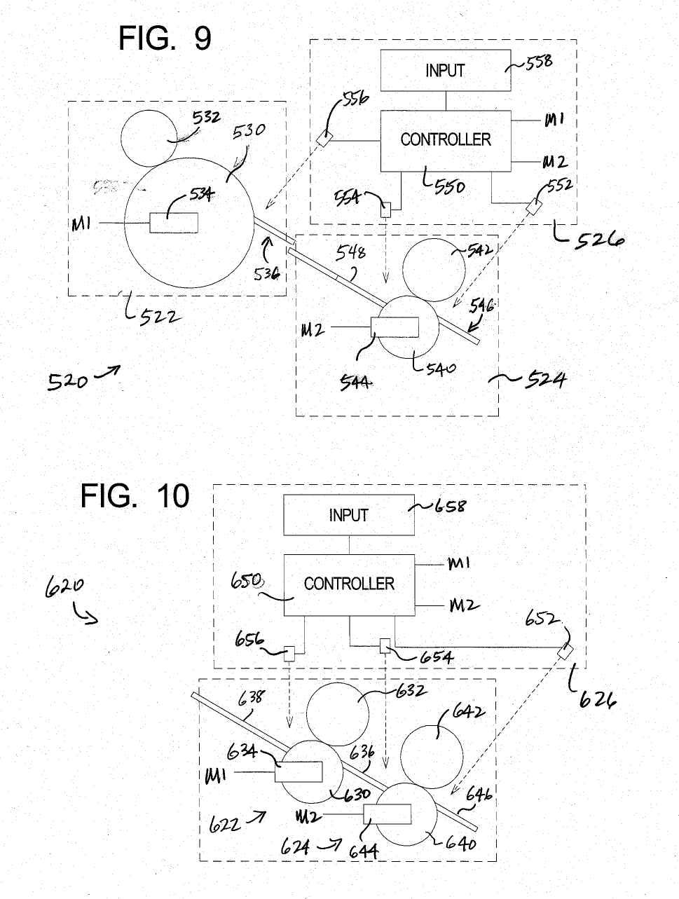

FIG. 9 depicts an example dewatering system 520 constructed in accordance with and embodying the principles of the present invention. The example dewatering system 520 comprises a pre-processing stage separator 522, an output roller press 524, and a control system 526.

The example pre-processing stage separator 522 is similar to the separator system 20 described above and comprises a base roller 530, a press roller 532, an input drive system 534, and a scraper 536. The pre-processing stage separator 522 processes feed material to obtain a pre-processed mat that is formed on the scraper 536, and the pre-processing drive system 534 causes rotation of a base roller 530 and thus determines a pre-processing rate of the pre-processing stage separator 522. The pre-processed mat contains less liquid than the feed material.

The example output roller system 524 is a single stage roller press like either of the roller press systems 52a or 52b described above and comprises a perforated roller 540, a press roller 542, an output drive system 544, a scraper 546, and a feed tray 548. The pre-processed mat on the scraper 534 of the pre-processing stage separator 522 collects on the feed tray 548 and is subsequently fed into the output roller system 524. The output roller system 524 processes the pre-processed mat to obtain an output mat, and the drive system 544 causes rotation of the perforated roller 540 to determine an output processing rate of the output roller system 524. The output mat contains less liquid than the pre-processed mat.

The example control system 526 comprises a controller 550, a first sensor 552, a second sensor 554, and a third sensor 556. An input device 558 may be provided to allow a user to program the controller 550. The first sensor 552 is arranged to generate a signal corresponding to at least one characteristic of the output mat. Based on the at least one characteristic of the output mat detected by the first sensor, the control system 526 controls the pre-processing drive system 534 and thus the pre-processing rate to maintain the at least one characteristic of the output mat within a predetermined range. The second and third sensors 554 and 556 are arranged to generate a signal indicative of a thickness of the pre-processed mat on the scraper 536 and feed tray 548, respectively. The second and third sensors 554 and 556 are optional and may be used to refine operation of the dewatering system 520.

In the example dewatering system 520, the first sensor 552 generates a signal indicative of a thickness of the output mat. The thickness of the output mat is in turn indicative of a moisture content of the output mat. The example control system 526 thus controls the pre-processing rate to maintain the thickness and/or moisture content of the output mat within a predetermined range.

FIG. 10 depicts an example dewatering system 620 constructed in accordance with and embodying the principles of the present invention. The example dewatering system 620 comprises a pre-processing stage roller press 622, an output roller press 624, and a control system 626. The pre-processing stage roller press 622 and output roller press 624 may take the form of a multiple- or two-stage roller press like the example roller press systems 32 and 34 described above. In addition, more than two roller presses may be arranged in sequence.

The example pre-processing roller press 622 is a single stage roller press that comprises a first perforated roller 630, a first press roller 632, a pre-processing drive system 634, a first scraper 636, and an input tray 638. The pre-processing roller press 622 processes feed material that collects on the input tray 638 to obtain a pre-processed mat that is formed on the first scraper 636, and a pre-processing drive system 634 causes rotation of a base roller 630 and thus determines a pre-processing rate of the pre-processing roller press 622. The pre-processed mat contains less liquid than the feed material.

The example output roller system 624 is a single stage roller press that comprises a second perforated roller 640, a second press roller 642, an output drive system 644, and a second scraper 646. The pre-processed mat on the scraper 636 of the pre-processing roller press 622 is fed into the output roller system 624. The output roller system 624 processes the pre-processed mat to obtain an output mat that collects on the second scraper 646, and the drive system 644 causes rotation of the perforated roller 640 to determine an output processing rate of the output roller system 624. The output mat contains less liquid than the pre-processed mat.

The example control system 626 comprises a controller 650, a first sensor 652, a second sensor 654, and a third sensor 656. An input device 658 may be provided to allow a user to program the controller 650. The first sensor 652 is arranged to generate a signal corresponding to at least one characteristic of the output mat. Based on the at least one characteristic of the output mat detected by the first sensor, the control system 626 controls the pre-processing drive system 634 and thus the pre-processing rate to maintain the at least one characteristic of the output mat within a predetermined range. The second and third sensors 654 and 656 are arranged to generate a signal indicative of a thickness of the pre-processed mat on the feed tray 638 and first scraper 636, respectively. The second and third sensors 654 and 656 are optional and may be used to refine operation of the dewatering system 620.

In the example dewatering system 620, the first sensor 652 generates a signal indicative of a thickness of the output mat. The thickness of the output mat is in turn indicative of a moisture content of the output mat. The example control system 626 thus controls the pre-processing rate to maintain the thickness and/or moisture content of the output mat within a predetermined range.

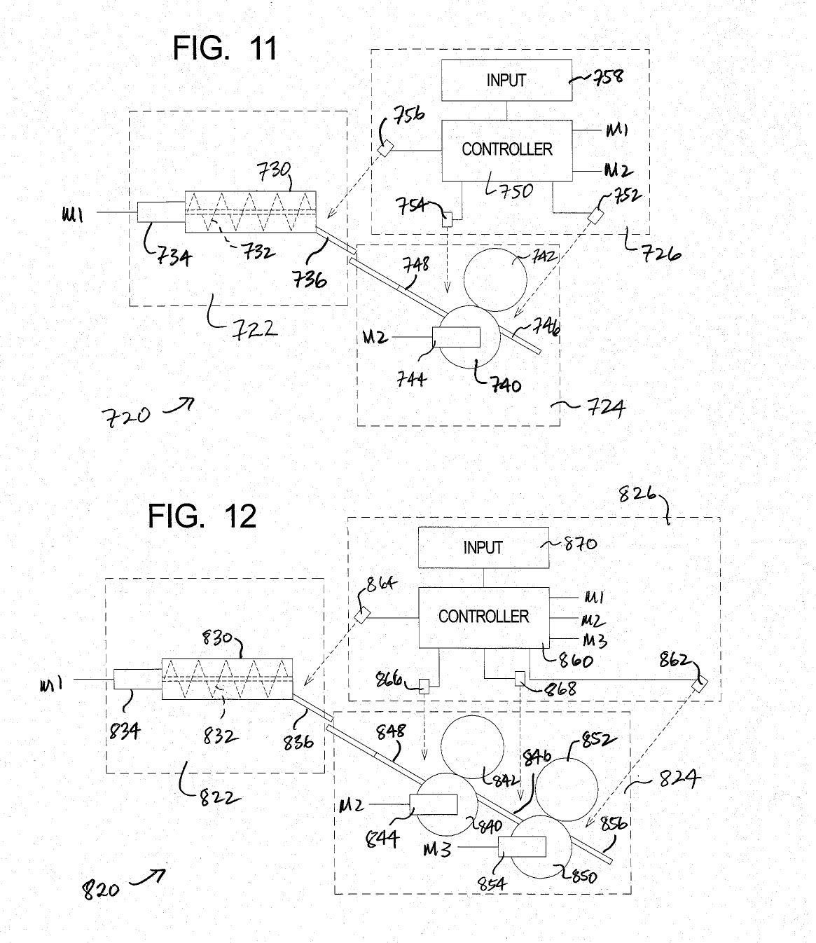

FIG. 11 depicts an example dewatering system 720 constructed in accordance with and embodying the principles of the present invention. The example dewatering system 720 comprises a pre-processing stage separator 722, an output roller press 724, and a control system 726.

The example pre-processing stage separator 722 is a conventional screw press comprising a screw housing 730, a screw member 732, an input drive system 734, and an output tray 736. The pre-processing stage separator 722 processes feed material to obtain a pre-processed mat that is formed on the output tray 736, and the pre-processing drive system 734 causes rotation of the screw member 732 and thus determines a pre-processing rate of the pre-processing stage separator 722. The pre-processed mat contains less liquid than the feed material.

The example output roller system 724 is a single stage roller press like either of the roller press systems 72a or 72b described above and comprises a perforated roller 740, a press roller 742, an output drive system 744, a scraper 746, and a feed tray 748. The pre-processed mat on the scraper 736 of the pre-processing stage separator 722 collects on the feed tray 748 and is subsequently fed into the output roller system 724. The output roller system 724 processes the pre-processed mat to obtain an output mat that collects on the scraper 746, and the drive system 744 causes rotation of the perforated roller 740 to determine an output processing rate of the output roller system 724. The output mat contains less liquid than the pre-processed mat.

The example control system 726 comprises a controller 750, a first sensor 752, a second sensor 754, and a third sensor 756. An input device 758 may be provided to allow a user to program the controller 750. The first sensor 752 is arranged to generate a signal corresponding to at least one characteristic of the output mat. Based on the at least one characteristic of the output mat detected by the first sensor, the control system 726 controls the pre-processing drive system 734 and thus the pre-processing rate to maintain the at least one characteristic of the output mat within a predetermined range. The second and third sensors 754 and 756 are arranged to generate a signal indicative of a thickness of the pre-processed mat on the scraper 736 and feed tray 748, respectively. The second and third sensors 754 and 756 are optional and may be used to refine operation of the dewatering system 720.

In the example dewatering system 720, the first sensor 752 generates a signal indicative of a thickness of the output mat. The thickness of the output mat is in turn indicative of a moisture content of the output mat. The example control system 726 thus controls the pre-processing rate to maintain the thickness and/or moisture content of the output mat within a predetermined range.

FIG. 12 depicts an example dewatering system 820 constructed in accordance with and embodying the principles of the present invention. The example dewatering system 820 comprises a pre-processing stage separator 822, an output roller press system 824, and a control system 826.

The example pre-processing stage separator 822 is a conventional screw press comprising a screw housing 830, a screw member 832, an input drive system 834, and an output tray 836. The pre-processing stage separator 822 processes feed material to obtain a pre-processed mat that is formed on the output tray 836, and the pre-processing drive system 834 causes rotation of the screw member 832 and thus determines a pre-processing rate of the pre-processing stage separator 822. The pre-processed mat contains less liquid than the feed material.

The example output roller system 824 is a dual stage roller press like the combination of the roller press systems 82a or 82b described above. In particular, the output roller system 824 comprises a first stage roller press comprising a first perforated roller 840, a first press roller 842, a first output drive system 844, a first scraper 846, and a first feed tray 848 and a second stage roller press comprising a second perforated roller 850, a second press roller 852, a second output drive system 854, and a second scraper 856. The pre-processed mat on the scraper 836 of the pre-processing stage separator 822 collects on the feed tray 848 and is subsequently fed into the output roller system 824. The output roller system 824 processes the pre-processed mat to obtain an output mat that collects on the scraper 846, and the first and second drive systems 844 and 854 cause rotation of the perforated rollers 840 and 850 to determine an output processing rate of the output roller system 824. The output mat contains less liquid than the pre-processed mat.

The example control system 826 comprises a controller 860, a first sensor 862, a second sensor 864, a third sensor 866, and a fourth sensor 868. An input device 870 may be provided to allow a user to program the controller 860. The first sensor 862 is arranged to generate a signal corresponding to at least one characteristic of the output mat. Based on the at least one characteristic of the output mat detected by the first sensor, the control system 826 controls the pre-processing drive system 834 and thus the pre-processing rate to maintain the at least one characteristic of the output mat within a predetermined range. The second, third, and fourth sensors 864, 866, and 868 are arranged to generate a signal indicative of a thickness of the pre-processed mat on the output tray 836, feed tray 848, and second scraper 846, respectively. The second, third, and fourth sensors 864, 866, and 868 are optional and may be used to refine operation of the dewatering system 820.

In the example dewatering system 820, the first sensor 862 generates a signal indicative of a thickness of the output mat. The thickness of the output mat is in turn indicative of a moisture content of the output mat. The example control system 826 thus controls the pre-processing rate to maintain the thickness and/or moisture content of the output mat within a predetermined range.

What is claimed is:

1. A dewatering system for removing liquids from feed material, the dewatering system comprising:
a pre-processing stage separator for processing the feed material at a pre-processing rate to obtain a pre-processed mat, where the pre-processed mat contains less liquid than the feed material;
an output roller press for processing the pre-processed mat at an output rate to obtain an output mat, where the output mat contains less liquid than the pre-processed mat; and
a control system for controlling the pre-processing rate based on at least one characteristic of the output mat to maintain the at least one characteristic of the output mat within a predetermined range.

2. A dewatering system as recited in claim 1, in which the pre-processing stage separator comprises an external screen separator.

3. A dewatering system as recited in claim 2, in which the control system controls the pre-processing rate by controlling a rotational speed of the external screen separator.

4. A dewatering system as recited in claim 1, in which the pre-processing stage separator comprises a first stage roller press.

5. A dewatering system as recited in claim 4, in which the control system controls the pre-processing rate by controlling a rotational speed of the first stage roller press.

6. A dewatering system as recited in claim 5, in which the pre-processing stage separator comprises:
an external screen separator; and
a first stage roller press.

7. A dewatering system as recited in claim 6, in which the control system controls the pre-processing rate by controlling a rotational speed of at least one of the external screen separator and the first stage roller press.

8. A dewatering system as recited in claim 1, in which the at least one characteristic of the output mat is indicative of a moisture content of the output mat.

9. A dewatering system as recited in claim 1, in which the at least one characteristic of the output mat is a thickness of the output mat.

10. A dewatering system as recited in claim 1, in which the control system further controls the pre-processing rate to optimize throughput of the dewatering system while maintaining the at least one characteristic of the output mat within the predetermined range.

11. A dewatering method for removing liquids from feed material comprising the steps of:
processing the feed material at a pre-processing rate to obtain a pre-processed mat, where the pre-processed mat contains less liquid than the feed material;
processing the pre-processed mat at an output rate to obtain an output mat, where the output mat contains less liquid than the pre-processed mat; and
controlling the pre-processing rate based on at least one characteristic of the output mat to maintain the at least one characteristic of the output mat within a predetermined range.

12. A dewatering method as recited in claim 11, in which the step of processing the feed material comprises the step of providing an external screen separator.

13. A dewatering method as recited in claim 12, in which the step of controlling the pre-processing rate comprises the step of controlling a rotational speed of the external screen separator.

14. A dewatering method as recited in claim 11, in which the step of processing the feed material comprises the step of providing a first stage roller press.

15. A dewatering method as recited in claim 14, in which the step of controlling the pre-processing rate comprises the step of controlling a rotational speed of the first stage roller press.

16. A dewatering method as recited in claim 11, in which the step of processing the feed material comprises the steps of:
providing an external screen separator; and
providing a first stage roller press.

17. A dewatering method as recited in claim 16, in which the step of controlling the pre-processing rate comprises the step of controlling a rotational speed of at least one of the external screen separator and the first stage roller press.

18. A dewatering method as recited in claim 11, in which the at least one characteristic of the output mat is indicative of a moisture content of the output mat.

19. A dewatering method as recited in claim 11, in which the at least one characteristic of the output mat is a thickness of the output mat.

20. A dewatering method as recited in claim 11, in which the step of controlling the pre-processing rate comprises the step of controlling the pre-processing rate to optimize throughput of the dewatering system while maintaining the at least one characteristic of the output mat within the predetermined range.
